(19) United States
(12) Patent Application Publication
(10) Pub. No.: US 2016/0140554 A1
(43) Pub. Date: May 19, 2016

(54) METHOD AND SYSTEM FOR CONDUCTING RESOURCE TRANSFER USING A SOCIAL NETWORKING APPLICATION

(71) Applicant: TENCENT TECHNOLOGY (SHENZHEN) COMPANY LIMITED, Shenzhen (CN)

(72) Inventor: Juan Sun, Shenzhen (CN)

(21) Appl. No.: 15/003,643

(22) Filed: Jan. 21, 2016

Related U.S. Application Data
(63) Continuation of application No. PCT/CN2014/086302, filed on Sep. 11, 2014.

(30) Foreign Application Priority Data
Dec. 31, 2013 (CN) 201310753742.7

(51) Int. Cl. G06Q 20/40; G06Q 50/00; H04L 12/58

(52) U.S. Cl. CPC G06Q 20/401; H04L 51/32; G06Q 50/01

(57) ABSTRACT

A computer server receives a structured message from a first user terminal, the structured message including an event title, one or more recipient user accounts and respective resources requested from the recipient user accounts, and a requesting user account. For each recipient user account, the computer server sends a structured request to a respective user terminal associated with the recipient user account and receives a structured response from the respective user terminal, the structured response including the event title, the requesting user account, and an authorization of transferring a predefined amount of resource to the requesting user account. The computer server then performs a resource transfer operation between the recipient user account and the requesting user account in accordance with the predefined amount and sends structured messages to the respective user terminals, the structured messages indicating a completion of the resource transfer.

### CROSS REFERENCE TO RELATED APPLICATIONS

This is a continuation application of International Patent Application No. PCT/CN2014/086302 filed on Sep. 11, 2014, which claims priority to Chinese Patent Application No. 201310753742.7 filed on Dec. 31, 2013, the disclosure of which is incorporated by reference herein in its entirety.

### FIELD OF THE TECHNOLOGY

The present disclosure relates to the field of Internet technologies, and in particular, to a data processing method, a data processing server, a user terminal and a system.

### BACKGROUND OF THE DISCLOSURE

With rapid development of Internet technologies, people are increasingly accustomed to online resource transfer over the Internet, however, based on existing online resource transfer technologies, when a user hopes to initiate transfer of resources in an account of another user into his own account, he only can communicate with the other side through a telephone, a social application tool or other manners to let the other side initiate a resource outward-transfer flow according to account information of both sides, the communication process generated midway and the resource outward-transfer flow initiated according to account information resources of the both sides are both very complicated, and user account information is easy to leak in the existing resource transfer process, which causes a safety hazard to user property.

### SUMMARY

The above deficiencies and other problems associated with the conventional approach of resource transfer are reduced or eliminated by the present application disclosed below. In some embodiments, the present application is implemented in a computer server that has one or more processors, memory and one or more modules, programs or sets of instructions stored in the memory for performing multiple functions and communicating with one or more client devices (e.g., a computer or a smartphone) that has one or more processors, memory and one or more modules, programs or sets of instructions stored in the memory for performing multiple functions. Instructions for performing these functions may be included in a computer program product configured for execution by one or more processors.

One aspect of the present application involves a method of conducting resource transfer uses a social networking application running on a computer server. The computer server receives a structured message from a first user terminal, the structured message including an event title, one or more recipient user accounts and respective resources requested from the recipient user accounts, and a requesting user account. For each of the recipient user accounts, the computer server sends a structured request to a respective user terminal associated with the recipient user account and receives a structured response from the respective user terminal, the structured response including the event title, the requesting user account, and an authorization of transferring a predefined amount of resource to the requesting user account. The computer server then performs a resource transfer operation between the recipient user account and the requesting user account in accordance with the predefined amount and sends structured messages to the respective user terminals. The structured message to the first user terminal indicates that a predefined amount of resource has been transferred from a respective recipient user account to the requesting user account and the structured message to the user terminal associated with the respective recipient user account indicates that the predefined amount of resource has been transferred to the requesting user account.

Another aspect of the present application involves a computer server including one or more processors, memory, one or more program modules stored in the memory and to be executed by the one or more processors. The program modules further include: receiving a structured message from a first user terminal, the structured message including an event title, one or more recipient user accounts and respective resources requested from the recipient user accounts, and a requesting user account; for each of the one or more recipient user accounts: sending a structured request to a respective user terminal associated with the recipient user account, the structured request including the event title, the requesting user account, and an amount of resource requested by the requesting user account, and one or more user-actionable items; receiving a structured response from the respective user terminal, the structured response including the event title, the requesting user account, and an authorization of transferring a predefined amount of resource to the requesting user account; and performing a resource transfer operation between the recipient user account and the requesting user account in accordance with the predefined amount; and sending structured messages to the respective user terminals, wherein the structured message to the first user terminal indicates that a predefined amount of resource has been transferred from a respective recipient user account to the requesting user account and the structured message to the user terminal associated with the respective recipient user account indicates that the predefined amount of resource has been transferred to the requesting user account.

Another aspect of the present application involves a non-transitory computer readable storage medium stores one or more program modules in connection with a computer server having one or more processors, the program modules including instructions for execution by one or more processors. The instructions, when executed by the one or more processors, cause the computer server to perform the following instructions: receiving a structured message from a first user terminal, the structured message including an event title, one or more recipient user accounts and respective resources requested from the recipient user accounts, and a requesting user account; for each of the one or more recipient user accounts: sending a structured request to a respective user terminal associated with the recipient user account, the structured request including the event title, the requesting user account, and an amount of resource requested by the requesting user account, and one or more user-actionable items; receiving a structured response from the respective user terminal, the structured response including the event title, the requesting user account, and an authorization of transferring a predefined amount of resource to the requesting user account; and performing a resource transfer operation between the recipient user account and the requesting user account in accordance with the predefined amount; and sending structured messages to the respective user terminals, wherein the structured message to the first user terminal indicates that a predefined amount of resource has been transferred from a respective recipient user account to the requesting user account and the structured message to the user terminal associated with the respective recipient user account indicates that the predefined amount of resource has been transferred to the requesting user account.

Various advantages of the present application are apparent in light of the descriptions below.

### BRIEF DESCRIPTION OF THE DRAWINGS

The aforementioned features and advantages of the present disclosure as well as additional features and advantages thereof will be more clearly understood hereinafter as a result of a detailed description of preferred embodiments when taken in conjunction with the drawings.

To illustrate the technical solutions according to the embodiments of the present disclosure or the prior art more clearly, the accompanying drawings for describing the embodiments or the prior art are introduced briefly in the following. Apparently, the accompanying drawings in the following description are only some embodiments of the present disclosure; persons of ordinary skill in the art may obtain other drawings according to the accompanying drawings without paying any creative efforts.

FIG. 1 is a schematic view of a flow of a data processing method according to an embodiment of the present disclosure;

FIG. 2 is a schematic view of a flow of a data processing method according to another embodiment of the present disclosure;

FIG. 3 is a schematic view of a flow of a data processing method according to still another embodiment of the present disclosure;

FIG. 4 is a schematic structural view of a data processing server according to an embodiment of the present disclosure;

FIG. 5 is a schematic structural view of a data processing server according to another embodiment of the present disclosure;

FIG. 6 is a schematic structural view of a user terminal of a requesting user according to an embodiment of the present disclosure;

FIG. 7 is a schematic structural view of a user terminal of a requesting user according to another embodiment of the present disclosure;

FIG. 8 is a schematic structural view of a user terminal of a requested user according to an embodiment of the present disclosure;

FIG. 9 is a schematic structural view of a user terminal of a requested user according to another embodiment of the present disclosure;

FIG. 10 is a schematic structural view of a data processing system according to an embodiment of the present disclosure;

FIG. 11 is an exemplary view of a resource inward-transfer message according to an embodiment of the present disclosure; and

FIGS. 12A-12E are exemplary screenshots of displaying resource transfer related messages in a social networking application running on user terminals according to an embodiment of the present disclosure.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The technical solution in the embodiments of the present disclosure will be clearly and fully described below with reference to the accompanying drawings in the embodiments of the present disclosure. It is obvious that the embodiments to be described are only a part rather than all of the embodiments of the present disclosure. All other embodiments derived by persons of ordinary skill in the art based on the embodiments of the present disclosure without carrying out creative activities should fall within the scope of the present disclosure.

The resources involved in data processing in the embodiments of the present disclosure may be information resources, financial resources, monetary values, virtual financial resources, virtual monetary values, transaction goods, service orders and other things available for transaction or transfer.

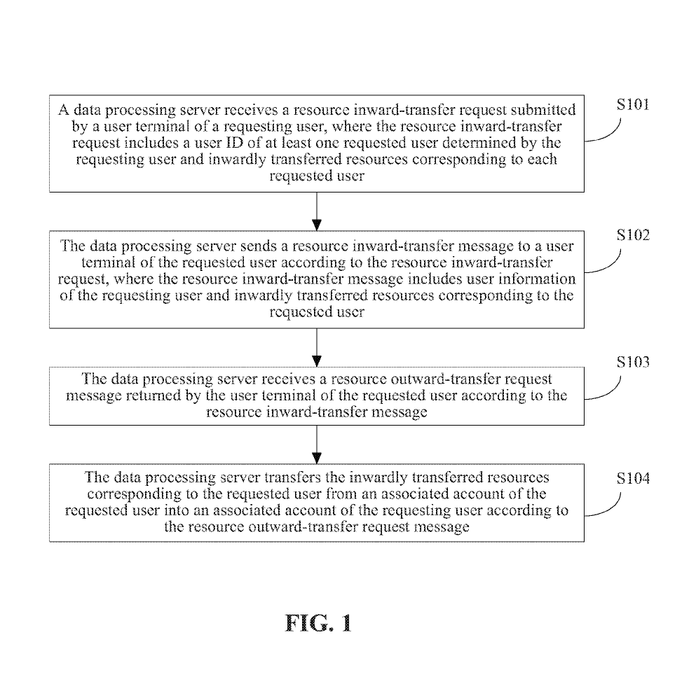

FIG. 1 is a schematic view of a flow of a data processing method according to an embodiment of the present disclosure, and the data processing method described in this embodiment is mainly described from a data processing server side. As shown in FIG. 1, the data processing method in this embodiment may include the following steps.

S101. A data processing server receives a resource inward-transfer request submitted by a user terminal of a requesting user, wherein the resource inward-transfer request includes a user ID of at least one requested user determined by the requesting user and inwardly transferred resources corresponding to each requested user.

In specific implementation, the requesting user may set the resource inward-transfer request in a client interface of the user terminal, including a user ID of at least one requested user determined and inwardly transferred resources corresponding to each requested user, which may also include summary of content of resource inward-transfer items, for example, K song activities, FB activities, enrichment AA and the total amount, messages of a resource requesting side and the like, and upon completion of setting, the resource inward-transfer request may be submitted to the data processing server. In an alternative embodiment, the resource inward-transfer request may be submitted to the data processing server through a social application client (for example, an instant messaging client or a Social Networking Services (SNS) client) operating on the user terminal, for example, the data processing server may own a particular social application account (which, for example, may be a public number), and the requesting user may submit the resource inward-transfer request to the data processing server through a social application session with the social application account of the data processing server.

The requesting user may select at least one contact from a list of social application contacts displayed in the social application client as the requested user. Further, in an alternative embodiment, the user terminal may further send out acoustic information according to an operation that the requesting user presses down a resource inward-transfer initiate key (for example, a key of “press to initiate resource inward-transfer”), a user terminal of a requested user nearby acquires the acoustic information and then notifies the data processing server or a social application server, and the data processing server or the social application server sends user information of the user terminal acquiring the acoustic information to the user terminal of the requesting user, so that the user terminal of the requesting user may determine at least one user of the user terminal acquiring the acoustic information as the requested user. In specific implementation, the user terminal of the requesting user may invoke a built-in acoustic sounding device to send out particular acoustic information when the requesting user presses down the resource inward-transfer initiate key, the particular acoustic information may make an agreement with the data processing server or the social application server previously, or currently notify the data processing server or the social application server about the acoustic information sent out (and vice versa, that is, the user terminal of the requesting user receives acoustic information sent by the data processing server or the social application server, and invokes the acoustic sounding device to send out the acoustic information), and in the meantime, the user terminal of the requested user nearby may invoke a built-in acoustic acquisition device to acquire surrounding acoustic information when the requested user presses down a resource inward-transfer participate key (for example, a key of “press to participate in resource inward-transfer”), and report the acquired acoustic information to the data processing server or the social application server, so that the data processing server or the social application server knows users corresponding to the user terminal acquiring the acoustic information, thereby sending user information of the user terminal to the user terminal of the requesting user, letting the latter confirm a part or all of the users as requested users of the initiated resource inward-transfer request.

S102. The data processing server sends a resource inward-transfer message to a user terminal of the requested user according to the resource inward-transfer request, wherein the resource inward-transfer message includes user information of the requesting user and inwardly transferred resources corresponding to the requested user.

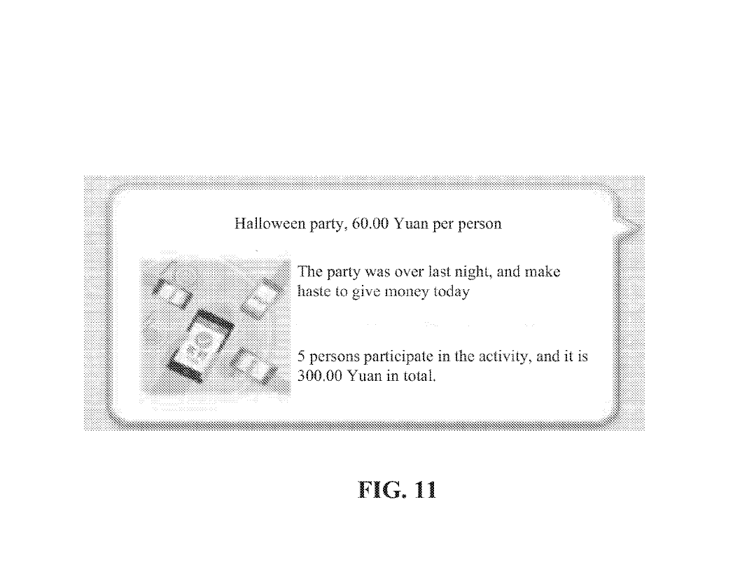

In specific implementation, the data processing server may send a resource inward-transfer message to each requested user according to the user ID of the requested user in the resource inward-transfer request, and the user ID of the requested user is identification information that may uniquely determine a certain requested user, for example, a user name (unique), a social application account or the like. Exemplarily, the resource inward-transfer message may, as shown in FIG. 11, include resource inward-transfer items, activity content, the number of inwardly transferred resources, user information of the requesting user and other information.

In an alternative embodiment, the data processing server may send the resource inward-transfer message to the user terminal of the requested user through a social application session with the requested user, for example, the data processing server uses a corresponding social application account (which, for example, may be a public number), and the resource inward-transfer request is submitted to the data processing server through a social application session (for example, an instant messaging session or an SNS session) with a social application account of the requested user. The data processing server may previously acquire user information of the requesting user from the social application server according to a user ID of the requesting user, which, for example, may include a user name, user avatar information and the like, and the resource inward-transfer message may let the requested user intuitively understand which user initiates the current resource inward-transfer message, what needs resource inward-transfer due to a matter or an activity, so as to rapidly decide whether resource outward-transfer is required.

S103. The data processing server receives a resource outward-transfer request message returned by the user terminal of the requested user according to the resource inward-transfer message.

In specific implementation, after the user terminal of the requested user receives the resource inward-transfer message, the requested user may return a resource outward-transfer request message to the data processing server by clicking on a resource outward-transfer link in the resource inward-transfer message, which indicates agreeing with resource outward-transfer on the resource inward-transfer request.

In an alternative embodiment, after the user terminal of the requested user receives the resource inward-transfer message, the requested user may send a resource transfer query request to the data processing server by clicking on the resource inward-transfer message or a link of viewing resource inward-transfer details, the data processing server returns a resource outward-transfer message to the user terminal of the requested user according to the resource transfer query request, the resource outward-transfer message may include further resource outward-transfer information, for example, detailed information of the requesting user (for example, the previous resource inward-transfer message does not include a user avatar of the requesting user, and the resource outward-transfer message may include the user avatar of the requesting user), an associated resource outward-transfer account for resource inward-transfer, resource inward-transfer activity details and the like, for prompting the requested user to acknowledge whether resources are transferred to the requesting user, and when the requested user further acknowledges resource outward-transfer according to the resource outward-transfer message, for example, clicks on a key or link of “I want resource outward-transfer” in the resource outward-transfer message, the user terminal of the requested user sends the resource outward-transfer request message to the data processing server.

S104. The data processing server transfers the inwardly transferred resources corresponding to the requested user from an associated account of the requested user into an associated account of the requesting user according to the resource outward-transfer request message.

In specific implementation, the data processing server may query associated accounts of the requesting user and the requested user according to user IDs of the requesting user and the requested user respectively, for example, resource outward-transfer accounts bound to the social application account, bank accounts and the like. So, the data processing server transfers the inwardly transferred resources corresponding to the requested user from the associated account of the requested user into the associated account of the requesting user according to the resource outward-transfer request message.

In an alternative embodiment, the data processing server may first transfer the inwardly transferred resources corresponding to the requested user from an associated account of the requested user into a preset account of the data processing server according to the resource outward-transfer request message, for example, an associated account of the public number corresponding to the data processing server, and then transfer the inwardly transferred resources corresponding to the requested user from the preset account of the data processing server into an associated account of the requesting user.

Further, in an alternative embodiment, the data processing server may send resource outward-transfer parameter information to the user terminal of the requested user according to the resource outward-transfer request message, so that the user terminal of the requested user sends a resource outward-transfer request to a resource outward-transfer server according to the resource outward-transfer parameter information, and the resource outward-transfer server transfers the inwardly transferred resources corresponding to the requested user from the associated account of the requested user into the associated account of the requesting user according to the resource outward-transfer request. The resource outward-transfer parameter information includes the associated account of the requested user, the associated account of the requesting user, resource transfer amount and the like. In specific implementation, after receiving the resource outward-transfer parameter information, the user terminal of the requested user may automatically invoke a resource outward-transfer interface of the social application client to send a resource outward-transfer request to a resource outward-transfer server, so that the resource outward-transfer server transfers the inwardly transferred resources corresponding to the requested user from the associated account of the requested user into the associated account of the requesting user according to the resource outward-transfer request.

Further, in an alternative embodiment, after transferring the inwardly transferred resources corresponding to the requested user from an associated account of the requested user into an associated account of the requesting user according to the resource outward-transfer request message, the data processing server may further send a resource transfer success message to the user terminal of the requesting user, so as to notify the requesting user that the inwardly transferred resources of the requested user through resource outward-transfer have been received.

The data processing server in this embodiment may send a resource inward-transfer message to a designated requested user according to a resource inward-transfer request sent by a requesting user, so that the requested user may initiate resource outward-transfer according to the resource inward-transfer message, and it is unnecessary to input user account information in the resource inward-transfer process, which ensures security of the user account information, and achieves safe and efficient online resource inward-transfer.

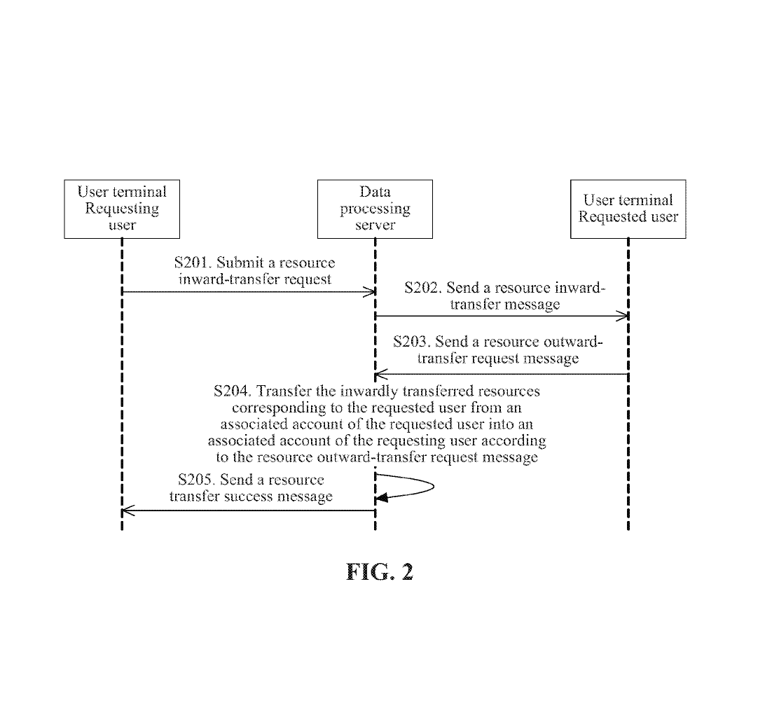

FIG. 2 is a schematic view of a flow of a data processing method according to another embodiment of the present disclosure, and the data processing method described in this embodiment is mainly described from three sides, a data processing server, a user terminal of a requesting user and a user terminal of a requested user. As shown in FIG. 2, the data processing method in this embodiment may include the following steps.

S201. A user terminal of a requesting user submits a resource inward-transfer request to a data processing server, wherein the resource inward-transfer request includes a user ID of at least one requested user determined by the requesting user and inwardly transferred resources corresponding to each requested user.

In specific implementation, the requesting user may set the resource inward-transfer request in a client interface of the user terminal, including a user ID of at least one requested user determined and inwardly transferred resources corresponding to each requested user, which may also include summary of content of resource inward-transfer items, for example, K song activities, FB activities, enrichment AA and the total amount, messages of a resource requesting side and the like, and upon completion of setting, the resource inward-transfer request may be submitted to the data processing server. In an alternative embodiment, the resource inward-transfer request may be submitted to the data processing server through a social application client operating on the user terminal, for example, the data processing server may own a particular social application account (which, for example, may be a public number), and the requesting user may submit the resource inward-transfer request to the data processing server through a social application session with the social application account of the data processing server.

The requesting user may select at least one contact from a list of social application contacts displayed in the social application client as the requested user. Further, in an alternative embodiment, the user terminal may further send out acoustic information according to an operation that the requesting user presses down a resource inward-transfer initiate key (for example, a key of “press to initiate resource inward-transfer”), a user terminal of a requested user nearby acquires the acoustic information and then notifies the data processing server or a social application server, and the data processing server or the social application server sends user information of the user terminal acquiring the acoustic information to the user terminal of the requesting user, so that the user terminal of the requesting user may determine at least one user of the user terminal acquiring the acoustic information as the requested user. In specific implementation, the user terminal of the requesting user may invoke a built-in acoustic sounding device to send out particular acoustic information when the requesting user presses down the resource inward-transfer initiate key, the particular acoustic information may make an agreement with the data processing server or the social application server previously, or currently notify the data processing server or the social application server about the acoustic information sent out (and vice versa, that is, the user terminal of the requesting user receives acoustic information sent by the data processing server or the social application server, and invokes the acoustic sounding device to send out the acoustic information), and in the meantime, the user terminal of the requested user nearby may invoke a built-in acoustic acquisition device to acquire surrounding acoustic information when the requested user presses down a resource inward-transfer participate key (for example, a key of “press to participate in resource inward-transfer”), and report the acquired acoustic information to the data processing server or the social application server, so that the data processing server or the social application server knows users corresponding to the user terminal acquiring the acoustic information, thereby sending user information of the user terminal to the user terminal of the requesting user, letting the latter confirm a part or all of the users as requested users of the initiated resource inward-transfer request.

S202. The data processing server receives the resource inward-transfer request submitted by the user terminal of the requesting user, and sends a resource inward-transfer message to a user terminal of the requested user according to the resource inward-transfer request, wherein the resource inward-transfer message includes user information of the requesting user and inwardly transferred resources corresponding to the requested user.

In specific implementation, the data processing server may send a resource inward-transfer message to each requested user according to the user ID of the requested user in the resource inward-transfer request, and the user ID of the requested user is identification information that may uniquely determine a certain requested user, for example, a user name (unique), a social application account or the like. Exemplarily, the resource inward-transfer message may, as shown in FIG. 11, include resource inward-transfer items, activity content, the number of inwardly transferred resources, user information of the requesting user and other information.

In an alternative embodiment, the data processing server may send the resource inward-transfer message to the user terminal of the requested user through a social application session with the requested user, for example, the data processing server uses a corresponding social application account (which, for example, may be a public number), and the resource inward-transfer request is submitted to the data processing server through a social application session (for example, an instant messaging session or an SNS session) with a social application account of the requested user. The data processing server may previously acquire user information of the requesting user from the social application server according to a user ID of the requesting user, which, for example, may include a user name, user avatar information and the like, and the resource inward-transfer message may let the requested user intuitively understand which user initiates the current resource inward-transfer message, what needs resource inward-transfer due to a matter or an activity, so as to rapidly decide whether resource outward-transfer is required.

S203. The user terminal of the requesting user returns a resource outward-transfer request message to the data processing server according to the resource inward-transfer message.

In specific implementation, after the user terminal of the requested user receives the resource inward-transfer message, the requested user may return a resource outward-transfer request message to the data processing server by clicking on a resource outward-transfer link in the resource inward-transfer message, which indicates agreeing with resource outward-transfer on the resource inward-transfer request.

In an alternative embodiment, after the user terminal of the requested user receives the resource inward-transfer message, the requested user may send a resource transfer query request to the data processing server by clicking on the resource inward-transfer message or a link of viewing resource inward-transfer details, the data processing server returns a resource outward-transfer message to the user terminal of the requested user according to the resource transfer query request, the resource outward-transfer message may include further resource outward-transfer information, for example, detailed information of the requesting user (for example, the previous resource inward-transfer message does not include a user avatar of the requesting user, and the resource outward-transfer message may include the user avatar of the requesting user), an associated resource outward-transfer account for resource inward-transfer, resource inward-transfer activity details and the like, for prompting the requested user to acknowledge whether resources are transferred to the requesting user, and when the requested user further acknowledges resource outward-transfer according to the resource outward-transfer message, for example, clicks on a key or link of “I want resource outward-transfer” in the resource outward-transfer message, the user terminal of the requested user sends the resource outward-transfer request message to the data processing server.

S204. The data processing server transfers the inwardly transferred resources corresponding to the requested user from an associated account of the requested user into an associated account of the requesting user according to the resource outward-transfer request message.

In specific implementation, the data processing server may query associated accounts of the requesting user and the requested user according to user IDs of the requesting user and the requested user respectively, for example, resource outward-transfer accounts bound to the social application account, bank accounts and the like. So, the data processing server transfers the inwardly transferred resources corresponding to the requested user from the associated account of the requested user into the associated account of the requesting user according to the resource outward-transfer request message.

In an alternative embodiment, the data processing server may first transfer the inwardly transferred resources corresponding to the requested user from an associated account of the requested user into a preset account of the data processing server according to the resource outward-transfer request message, for example, an associated account of the public number corresponding to the data processing server, and then transfer the inwardly transferred resources corresponding to the requested user from the preset account of the data processing server into an associated account of the requesting user.

Further, in an alternative embodiment, that the data processing server transfers the inwardly transferred resources corresponding to the requested user from an associated account of the requested user into an associated account of the requesting user according to the resource outward-transfer request message may specifically include:

the data processing server sending resource outward-transfer parameter information to the user terminal of the requested user according to the resource outward-transfer request message, so that the user terminal of the requested user sends a resource outward-transfer request to a resource outward-transfer server according to the resource outward-transfer parameter information, and the resource outward-transfer server transfers the inwardly transferred resources corresponding to the requested user from the associated account of the requested user into the associated account of the requesting user according to the resource outward-transfer request. The resource outward-transfer parameter information includes the associated account of the requested user, the associated account of the requesting user, resource transfer amount and the like. In specific implementation, after receiving the resource outward-transfer parameter information, the user terminal of the requested user may automatically invoke a resource outward-transfer interface of the social application client to send a resource outward-transfer request to a resource outward-transfer server, so that the resource outward-transfer server transfers the inwardly transferred resources corresponding to the requested user from the associated account of the requested user into the associated account of the requesting user according to the resource outward-transfer request.

S205. After transferring the inwardly transferred resources corresponding to the requested user from an associated account of the requested user into an associated account of the requesting user according to the resource outward-transfer request message, the data processing server may further send a resource transfer success message to the user terminal of the requesting user, so as to notify the requesting user that the inwardly transferred resources of the requested user through resource outward-transfer have been received.

The data processing server in this embodiment may send a resource inward-transfer message to a designated requested user according to a resource inward-transfer request sent by a requesting user, so that the requested user may initiate resource outward-transfer according to the resource inward-transfer message, and it is unnecessary to input user account information in the resource inward-transfer process, which ensures security of the user account information, and achieves safe and efficient online resource inward-transfer.

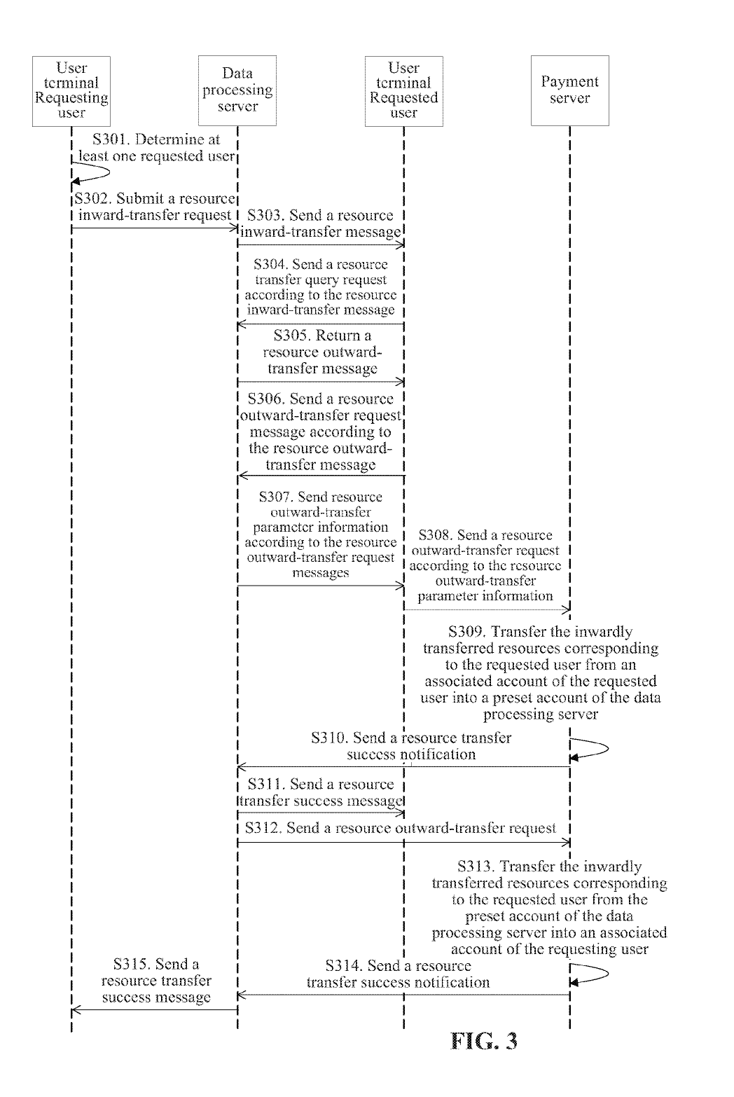

FIG. 3 is a schematic view of a flow of a data processing method according to still another embodiment of the present disclosure, and the data processing method described in this embodiment is mainly described from a data processing server, a user terminal of a requesting user and a user terminal of a requested user. As shown in FIG. 3, the data processing method in this embodiment may include the following steps.

S301. A user terminal of a requesting user determines at least one requested user.

In specific implementation, the user terminal of the requesting user determines the requested user in the following two manners.

1) The requesting user may select at least one contact from a list of social application contacts displayed in the social application client as the requested user.

2) The user terminal further sends out acoustic information according to an operation that the requesting user presses down a resource inward-transfer initiate key (for example, a key of “press to initiate resource inward-transfer”), a user terminal of a requested user nearby acquires the acoustic information and then notifies the data processing server or a social application server, and the data processing server or the social application server sends user information of the user terminal acquiring the acoustic information to the user terminal of the requesting user, so that the user terminal of the requesting user may determine at least one user of the user terminal acquiring the acoustic information as the requested user. In specific implementation, the user terminal of the requesting user may invoke a built-in acoustic sounding device to send out particular acoustic information when the requesting user presses down the resource inward-transfer initiate key, the particular acoustic information may make an agreement with the data processing server or the social application server previously, or currently notify the data processing server or the social application server about the acoustic information sent out (and vice versa, that is, the user terminal of the requesting user receives acoustic information sent by the data processing server or the social application server, and invokes the acoustic sounding device to send out the acoustic information), and in the meantime, the user terminal of the requested user nearby may invoke a built-in acoustic acquisition device to acquire surrounding acoustic information when the requested user presses down a resource inward-transfer participate key (for example, a key of “press to participate in resource inward-transfer”), and report the acquired acoustic information to the data processing server or the social application server, so that the data processing server or the social application server knows users corresponding to the user terminal acquiring the acoustic information, thereby sending user information of the user terminal to the user terminal of the requesting user, letting the latter confirm a part or all of the users as requested users of the initiated resource inward-transfer request.

S302. The user terminal of the requesting user submits a resource inward-transfer request to a data processing server, wherein the resource inward-transfer request includes a user ID of the at least one requested user determined by the requesting user and inwardly transferred resources corresponding to each requested user.

Specifically, in specific implementation, the requesting user may set the resource inward-transfer request in a client interface of the user terminal, including determining a user ID of the at least one requested user and inwardly transferred resources corresponding to each requested user, which may also include summary of content of resource inward-transfer items, for example, K song activities, FB activities, enrichment AA and the total amount, messages of a resource requesting side and the like, and upon completion of setting, the resource inward-transfer request may be submitted to the data processing server. In an alternative embodiment, the resource inward-transfer request may be submitted to the data processing server through a social application client operating on the user terminal, for example, the data processing server may own a particular social application account (which, for example, may be a public number), and the requesting user may submit the resource inward-transfer request to the data processing server through a social application session with the social application account of the data processing server.

S303. The data processing server receives the resource inward-transfer request submitted by the user terminal of the requesting user, and sends a resource inward-transfer message to a user terminal of the requested user according to the resource inward-transfer request, wherein the resource inward-transfer message includes user information of the requesting user and inwardly transferred resources corresponding to the requested user.

In specific implementation, the data processing server may send a resource inward-transfer message to each requested user according to the user ID of the requested user in the resource inward-transfer request, and the user ID of the requested user is identification information that may uniquely determine a certain requested user, for example, a user name (unique), a social application account or the like. Exemplarily, the resource inward-transfer message may, as shown in FIG. 11, include resource inward-transfer items, activity content, the number of inwardly transferred resources, user information of the requesting user and other information.

In an alternative embodiment, the data processing server may send the resource inward-transfer message to the user terminal of the requested user through a social application session with the requested user, for example, the data processing server uses a corresponding social application account (which, for example, may be a public number), and the resource inward-transfer request is submitted to the data processing server through a social application session (for example, an instant messaging session or an SNS session) with a social application account of the requested user. The data processing server may previously acquire user information of the requesting user from the social application server according to a user ID of the requesting user, which, for example, may include a user name, user avatar information and the like, and the resource inward-transfer message may let the requested user intuitively understand which user initiates the current resource inward-transfer message, what needs resource inward-transfer due to a matter or an activity, so as to rapidly decide whether resource outward-transfer is required.

S304. The user terminal of the requested user sends a resource transfer query request to the data processing server according to the resource inward-transfer message.

Specifically, after the user terminal of the requested user receives the resource inward-transfer message, the requested user may send a resource transfer query request to the data processing server by clicking on the resource inward-transfer message or a link of viewing resource inward-transfer details.

S305. The data processing server returns a resource outward-transfer message to the user terminal of the requested user according to the resource transfer query request. The resource outward-transfer message may include further resource outward-transfer information, for example, detailed information of the requesting user (for example, the previous resource inward-transfer message does not include a user avatar of the requesting user, and the resource outward-transfer message may include the user avatar of the requesting user), an associated resource outward-transfer account for resource inward-transfer, resource inward-transfer activity details and the like, for prompting the requested user to acknowledge whether resources are transferred to the requesting user.

S306. The user terminal of the requested user sends a resource outward-transfer request message to the data processing server.

Specifically, when the requested user further acknowledges resource outward-transfer according to the resource outward-transfer message, for example, clicks on a key or link of “I want resource outward-transfer” in the resource outward-transfer message, the user terminal of the requested user sends a resource outward-transfer request message to the data processing server.

S307. The data processing server sends resource outward-transfer parameter information to the user terminal of the requested user according to the resource outward-transfer request message.

Specifically, the data processing server may acquire the resource outward-transfer parameter information according to the resource outward-transfer request message and pack and send the resource outward-transfer parameter information to the user terminal of the requested user, which may include an associated account of the requested user, an associated account of the requesting user, resource transfer amount and the like.

S308. The user terminal of the requested user sends a resource outward-transfer request to a resource outward-transfer server according to the resource outward-transfer parameter information.

Specifically, after receiving the resource outward-transfer parameter information sent by the data processing server, the user terminal of the requested user may automatically invoke a resource outward-transfer initiate interface of the terminal, for example, a resource outward-transfer function of a social application terminal, to send a resource outward-transfer request to a preset resource outward-transfer server, wherein the resource outward-transfer request carries the resource outward-transfer parameter information.

S309. The resource outward-transfer server transfers the inwardly transferred resources corresponding to the requested user from an associated account of the requested user into a preset account of the resource outward-transfer server according to the resource outward-transfer request, for example, an associated account of the public number corresponding to the data processing server.

S310. The data processing server receives an arrival notification sent by the resource outward-transfer server, which indicates that the resource outward-transfer server has transferred the inwardly transferred resources corresponding to the requested user from the associated account of the requested user into a preset account of the data processing server.

S311. The data processing server sends a resource outward-transfer success message to the user terminal of the requested user.

S312. The data processing server sends a resource outward-transfer request to the resource outward-transfer server.

S313. The resource outward-transfer server transfers the inwardly transferred resources corresponding to the requested user from the preset account of the data processing server into an associated account of the requesting user according to the resource outward-transfer request sent by the data processing server.

S314. The data processing server receives the arrival notification sent by the resource outward-transfer server, which indicates that the resource outward-transfer server has transferred the inwardly transferred resources corresponding to the requested user from the preset account of the resource outward-transfer server into the associated account of the requesting user.

S315. The data processing server sends a resource transfer success message to the user terminal of the requesting user, so as to notify the requesting user that the inwardly transferred resources of the requested user through resource outward-transfer have been received.

The data processing server in this embodiment may send a resource inward-transfer message to a designated requested user according to a resource inward-transfer request sent by a requesting user, so that the requested user may initiate resource outward-transfer according to the resource inward-transfer message, and it is unnecessary to input user account information in the resource inward-transfer process, which ensures security of the user account information, and achieves safe and efficient online resource inward-transfer.

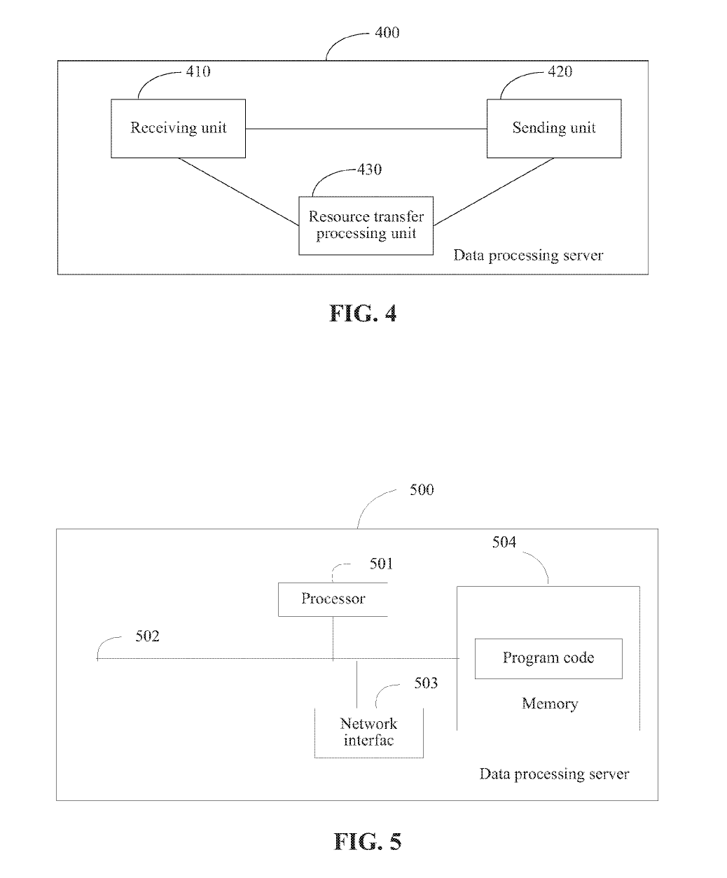

FIG. 4 is a schematic structural view of a data processing server according to an embodiment of the present disclosure, and as shown in FIG. 4, the data processing server 400 in this embodiment of the present disclosure may at least include:

a receiving unit 410, for receiving a resource inward-transfer request submitted by a user terminal of a requesting user, wherein the resource inward-transfer request includes a user ID of at least one requested user determined by the requesting user and inwardly transferred resources corresponding to each requested user.

In an alternative embodiment, the requesting user may submit the resource inward-transfer request to the data processing server 400 through a social application client operating on the user terminal thereof, for example, the data processing server 400 may own a particular social application account (which, for example, may be a public number), and the requesting user may submit the resource inward-transfer request to the data processing server 400 through a social application session with the social application account of the data processing server 400.

A sending unit 420 is included, for sending a resource inward-transfer message to a user terminal of the requested user according to the resource inward-transfer request, wherein the resource inward-transfer message includes user information of the requesting user and inwardly transferred resources corresponding to the requested user.

In specific implementation, the sending unit 420 may send a resource inward-transfer message to each requested user according to the user ID of the requested user in the resource inward-transfer request, and the user ID of the requested user is identification information that may uniquely determine a certain requested user, for example, a user name (unique), a social application account or the like. Exemplarily, the resource inward-transfer message may, as shown in FIG. 11, include resource inward-transfer items, activity content, the number of inwardly transferred resources, user information of the requesting user and other information.

In an alternative embodiment, the sending unit 420 may send the resource inward-transfer message to the user terminal of the requested user through a social application session between the data processing server 400 and the requested user, for example, the data processing server uses a corresponding social application account (which, for example, may be a public number), and the resource inward-transfer request is submitted to the data processing server through a social application session (for example, an instant messaging session or an SNS session) with a social application account of the requested user. The data processing server 400 may previously acquire user information of the requesting user from the social application server according to a user ID of the requesting user, which, for example, may include a user name, user avatar information and the like, and the resource inward-transfer message may let the requested user intuitively understand which user initiates the current resource inward-transfer message, what needs resource inward-transfer due to a matter or an activity, so as to rapidly decide whether resource outward-transfer is required.

The receiving unit 410 is further used for receiving a resource outward-transfer request message returned by the user terminal of the requested user according to the resource inward-transfer message.

In specific implementation, after the user terminal of the requested user receives the resource inward-transfer message, the requested user may return a resource outward-transfer request message to the data processing server 400 by clicking on a resource outward-transfer link in the resource inward-transfer message, which indicates agreeing with resource outward-transfer on the resource inward-transfer request.

A resource transfer processing unit 430 is included, for transferring the inwardly transferred resources corresponding to the requested user from an associated account of the requested user into an associated account of the requesting user according to the resource outward-transfer request message.

In specific implementation, the data processing server 400 may query associated accounts of the requesting user and the requested user according to user IDs of the requesting user and the requested user respectively, for example, resource outward-transfer accounts bound to the social application account, bank accounts and the like. So, the resource transfer processing unit 430 may transfer the inwardly transferred resources corresponding to the requested user from the associated account of the requested user into the associated account of the requesting user according to the resource outward-transfer request message.

In an alternative embodiment, the resource transfer processing unit 430 may first transfer the inwardly transferred resources corresponding to the requested user from an associated account of the requested user into a preset account of the data processing server 400 according to the resource outward-transfer request message, for example, an associated account of the public number corresponding to the data processing server 400, and then transfer the inwardly transferred resources corresponding to the requested user from the preset account of the data processing server 400 into an associated account of the requesting user.

In an alternative embodiment, the receiving unit 410 is further used for receiving a resource transfer query request sent by the user terminal of the requested user according to the resource inward-transfer message; and

the sending unit 420 is further used for returning a resource outward-transfer message to the user terminal of the requested user according to the resource transfer query request, wherein the resource outward-transfer message is used for prompting the requested user to acknowledge whether resources are transferred to the requesting user.

The resource outward-transfer message may include further resource outward-transfer information, for example, detailed information of the requesting user (for example, the previous resource inward-transfer message does not include a user avatar of the requesting user, and the resource outward-transfer message may include the user avatar of the requesting user), an associated resource outward-transfer account for resource inward-transfer, resource inward-transfer activity details and the like, for prompting the requested user to acknowledge whether resources are transferred to the requesting user.

Further, the receiving unit 410 receives a resource outward-transfer request message sent by the user terminal of the requested user according to the resource outward-transfer message. For example, when the requested user further acknowledges resource outward-transfer according to the resource outward-transfer message, for example, clicks on a key or link of “I want resource outward-transfer” in the resource outward-transfer message, the user terminal of the requested user sends the resource outward-transfer request message to the data processing server 400.

In an alternative embodiment, the resource transfer processing unit 430 is specifically used for: sending resource outward-transfer parameter information to the user terminal of the requested user according to the resource outward-transfer request message, so that the user terminal of the requested user sends a resource outward-transfer request to a resource outward-transfer server according to the resource outward-transfer parameter information, and the resource outward-transfer server transfers the inwardly transferred resources corresponding to the requested user from the associated account of the requested user into the associated account of the requesting user according to the resource outward-transfer request. In specific implementation, after receiving the resource outward-transfer parameter information sent by the data processing server, the user terminal of the requested user may automatically invoke a resource outward-transfer initiate interface of the terminal, for example, a resource outward-transfer function of a social application terminal, to send a resource outward-transfer request to a preset resource outward-transfer server, wherein the resource outward-transfer request carries the resource outward-transfer parameter information.

In an alternative embodiment, the sending unit 420 is further used for sending a resource transfer success message to the user terminal of the requesting user after the resource transfer processing unit 430 transfers the inwardly transferred resources corresponding to the requested user from an associated account of the requested user into an associated account of the requesting user according to the resource outward-transfer request message.

Specifically, if the resource transfer processing unit 430 makes the requested user send a resource outward-transfer request to a resource outward-transfer server according to resource outward-transfer parameter information by sending the resource outward-transfer parameter information to the requested user, the sending unit 420 may send a resource transfer success message to the user terminal of the requesting user according to the resource transfer success message sent by the resource outward-transfer server to the data processing server 400.

The data processing server 400 in this embodiment may send a resource inward-transfer message to a designated requested user according to a resource inward-transfer request sent by a requesting user, so that the requested user may initiate resource outward-transfer according to the resource inward-transfer message, and it is unnecessary to input user account information in the resource inward-transfer process, which ensures security of the user account information, and achieves safe and efficient online resource inward-transfer.

FIG. 5 is a schematic structural view of a data processing server according to another embodiment of the present disclosure, and as shown in FIG. 5, the data processing server 500 in this embodiment may include: at least one processor 501, for example, CPU, at least one network interface 503, a memory 504 and a communication bus 502. The communication bus 502 is used for implementing connections and communications between the components. The network interface 503 of the data processing server 500 in this embodiment of the present disclosure may include standard wired interfaces and wireless interfaces (for example, WI-FI interfaces), for communicating with a user terminal, a resource outward-transfer server or a social application server via Internet. The memory 504 may be a high-speed RAM memory, or may be a non-volatile memory, for example, at least one magnetic disk memory. The memory 504, alternatively, may also be at least one storage device located away from the processor 501. The memory 504 stores a set of program codes, and the processor 501 is used for calling the program codes stored in the memory 504, and is used for executing the following operations:

receiving a resource inward-transfer request submitted by a user terminal of a requesting user through the network interface 503, wherein the resource inward-transfer request includes a user ID of at least one requested user determined by the requesting user and inwardly transferred resources corresponding to each requested user;

sending a resource inward-transfer message to a user terminal of the requested user through the network interface 503 according to the resource inward-transfer request, wherein the resource inward-transfer message includes user information of the requesting user and inwardly transferred resources corresponding to the requested user; specifically, a resource inward-transfer message may be sent to a user terminal of the requested user through a social application session between the data processing server and the requested user;

receiving a resource outward-transfer request message returned by the user terminal of the requested user according to the resource inward-transfer message through the network interface 503; and

transferring the inwardly transferred resources corresponding to the requested user from an associated account of the requested user into an associated account of the requesting user according to the resource outward-transfer request message.

In an alternative embodiment, the data processing server may first transfer the inwardly transferred resources corresponding to the requested user from an associated account of the requested user into a preset account of the data processing server according to the resource outward-transfer request message, and then transfer the inwardly transferred resources corresponding to the requested user from the preset account of the data processing server into an associated account of the requesting user.

In an alternative embodiment, the processor 501 calls the program codes stored in the memory 504, and may further execute the following steps:

receiving a resource transfer query request sent by the user terminal of the requested user according to the resource inward-transfer message through the network interface 503;

returning a resource outward-transfer message to the user terminal of the requested user through the network interface 503 according to the resource transfer query request, wherein the resource outward-transfer message is used for prompting the requested user to acknowledge whether resources are transferred to the requesting user; and

receiving a resource outward-transfer request message sent by the user terminal of the requested user according to the resource outward-transfer message through the network interface 503.

In an alternative embodiment, the processor 501 calls the program codes stored in the memory 504, and may further execute the following step:

sending resource outward-transfer parameter information to the user terminal of the requested user through the network interface 503 according to the resource outward-transfer request message, so that the user terminal of the requested user sends a resource outward-transfer request to a resource outward-transfer server according to the resource outward-transfer parameter information, and the resource outward-transfer server transfers the inwardly transferred resources corresponding to the requested user from the associated account of the requested user into the associated account of the requesting user according to the resource outward-transfer request.

In an alternative embodiment, the processor 501 calls the program codes stored in the memory 504, and may further execute the following step:

sending a resource transfer success message to the user terminal of the requesting user through the network interface 503 after transferring the inwardly transferred resources corresponding to the requested user from an associated account of the requested user into an associated account of the requesting user according to the resource outward-transfer request message.

It should be noted that, a part or all of the steps in the flow of the data processing methods described in the previous text in combination with FIGS. 1-3 all could be implemented through the data processing server proposed in this embodiment.

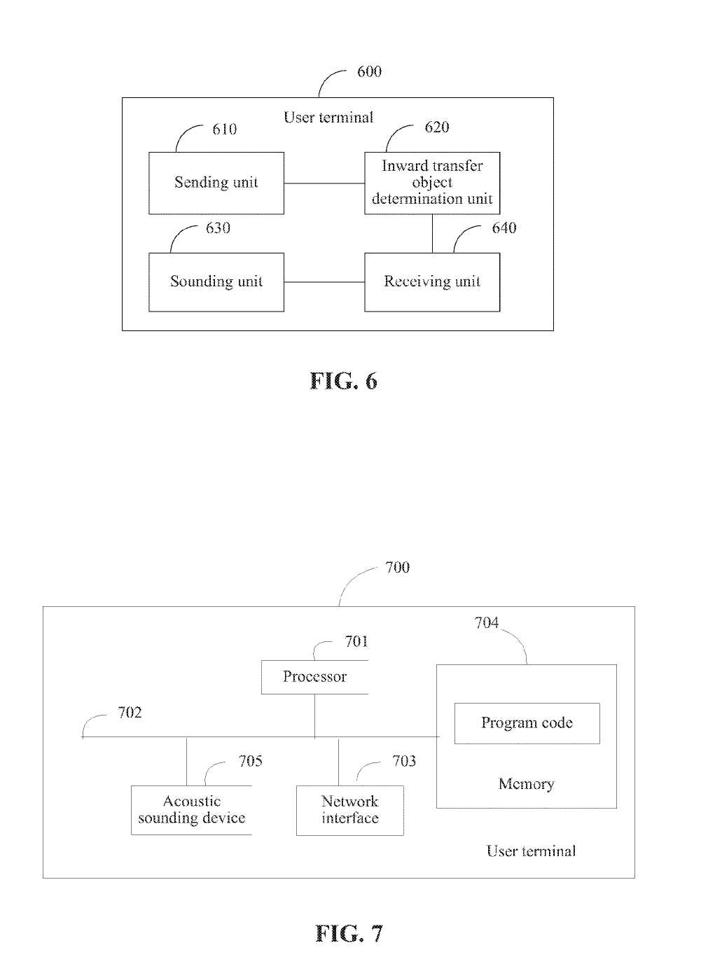

FIG. 6 is a schematic structural view of a user terminal of a requesting user according to an embodiment of the present disclosure, the user terminal in this embodiment of the present disclosure may include smart phones, tablet PCs, e-readers, vehicle terminals, wearable smart devices or the like, and as shown in FIG. 6, the user terminal 600 in this embodiment may at least include:

a sending unit 610, for submitting a resource inward-transfer request to a data processing server, wherein the resource inward-transfer request includes a user ID of at least one requested user determined by a user of the user terminal 600, that is, a requesting user, and inwardly transferred resources corresponding to each requested user, so that the data processing server sends a resource inward-transfer message to the user terminal 600 of the requested user according to the resource inward-transfer request, wherein the resource inward-transfer message includes user information of the requesting user and inwardly transferred resources corresponding to the requested user, and when receiving a resource outward-transfer request message returned by the user terminal 600 of the requested user according to the resource inward-transfer message, the data processing server transfers the inwardly transferred resources corresponding to the requested user from an associated account of the requested user into an associated account of the requesting user according to the resource outward-transfer request message.

In specific implementation, the requesting user may set the resource inward-transfer request in a client interface of the user terminal, including a user ID of at least one requested user determined and inwardly transferred resources corresponding to each requested user, which may also include summary of content of resource inward-transfer items, for example, K song activities, FB activities, enrichment AA and the total amount, messages of a resource requesting side and the like, and upon completion of setting, the sending unit 610 may submit the resource inward-transfer request to the data processing server. In an alternative embodiment, the sending unit 610 may submit the resource inward-transfer request to the data processing server through a social application client operating on the user terminal, for example, the data processing server may own a particular social application account (which, for example, may be a public number), and the sending unit 610 may submit the resource inward-transfer request to the data processing server through a social application session with the social application account of the data processing server.

In an alternative embodiment, the user terminal 600 further includes:

an inward transfer object determination unit 620, for determining at least one social application contact in social application contacts of the requesting user as the requested user.

In another alternative embodiment, the user terminal 600 further includes:

a sounding unit 630, for sending out acoustic information according to an operation that the requesting user presses down a resource inward-transfer initiate key.

In specific implementation, the sounding unit 630 may invoke a built-in acoustic sounding device to send out particular acoustic information when the requesting user presses down the resource inward-transfer initiate key, the particular acoustic information may make an agreement with the data processing server or the social application server previously, or currently notify the data processing server or the social application server about the acoustic information sent out (and vice versa, that is, the user terminal of the requesting user receives acoustic information sent by the data processing server or the social application server, and the sounding unit 630 invokes the acoustic sounding device to send out the acoustic information).

The receiving unit 640 is used for receiving user information of a user terminal acquiring the acoustic information sent by the data processing server.

In specific implementation, a user terminal of a requested user near the user terminal 600 of the requesting user may invoke a built-in acoustic acquisition device to acquire surrounding acoustic information when the requested user presses down a resource inward-transfer participate key (for example, a key of “press to participate in resource inward-transfer”), and report the acquired acoustic information to the data processing server or the social application server, so that the data processing server or the social application server knows the user terminal acquiring the acoustic information, and sends user information of the user terminal to the user terminal of the requesting user.

The inward transfer object determination unit 620 is used for determining at least one user of the user terminal acquiring the acoustic information as the requested user.

In specific implementation, the user information of the user terminal acquiring the acoustic information sent by the data processing server received by the receiving unit 640 may be displayed, and the user selects a part or all of the users as the requested user.

In an alternative embodiment, the receiving unit 640 may be further used for, after the sending unit 610 submits the resource inward-transfer request to the data processing server, receiving a resource transfer success message sent by the data processing server after transferring the inwardly transferred resources corresponding to the requested user from an associated account of the requested user into an associated account of the requesting user according to the resource outward-transfer request message.

The user terminal in this embodiment of the present disclosure may initiate online resource inward transfer to a determined requested user by submitting a resource inward-transfer request to a data processing server, and it is unnecessary to input user account information in the resource inward-transfer process, which ensures security of the user account information, and achieves safe and efficient online resource inward-transfer.

FIG. 7 is a schematic structural view of a user terminal of a requesting user according to another embodiment of the present disclosure, and as shown in FIG. 7, the user terminal 700 may include: at least one processor 701, for example, CPU, at least one network interface 703, a memory 704, a communication bus 702 and an acoustic sounding device 705. The communication bus 702 is used for implementing connections and communications between the components. The acoustic sounding device 705 is used for acquiring output particular acoustic information, for example, a horn, a loudspeaker or the like. The network interface 703 of the data processing server 700 in this embodiment of the present disclosure may include standard wired interfaces and wireless interfaces (for example, WI-FI interfaces), for communicating with the data processing server, a social application server or a resource outward-transfer server via Internet. The memory 704 may be a high-speed RAM memory, or may be a non-volatile memory, for example, at least one magnetic disk memory. The memory 704, alternatively, may also be at least one storage device located away from the processor 701. The memory 704 stores a set of program codes, and the processor 701 is used for calling the program codes stored in the memory 704, and is used for executing the following operations:

submitting a resource inward-transfer request to a data processing server through the network interface 703, wherein the resource inward-transfer request includes a user ID of at least one requested user determined by the requesting user and inwardly transferred resources corresponding to each requested user, so that the data processing server sends a resource inward-transfer message to a user terminal of the requested user according to the resource inward-transfer request, wherein the resource inward-transfer message includes user information of the requesting user and inwardly transferred resources corresponding to the requested user, and the data processing server, when receiving a resource outward-transfer request message returned by the user terminal of the requested user according to the resource inward-transfer message, transfers the inwardly transferred resources corresponding to the requested user from an associated account of the requested user into an associated account of the requesting user according to the resource outward-transfer request message.

In an alternative embodiment, the processor 701 calls the program codes stored in the processor 701, and may further execute the following operations:

before submitting a resource inward-transfer request to a data processing server, determining at least one social application contact in social application contacts of the requesting user as the requested user;

or before submitting a resource inward-transfer request to a data processing server, sending out acoustic information according to an operation that the requesting user presses down a resource inward-transfer initiate key through the acoustic sounding device 705;

receiving user information of a user terminal acquiring the acoustic information sent by the data processing server through the network interface 703; and

determining at least one user of the user terminal acquiring the acoustic information as the requested user.

In an alternative embodiment, the processor 701 calls the program codes stored in the processor 701, and may further execute the following operation:

after submitting a resource inward-transfer request to a data processing server, receiving through the network interface 703 a resource transfer success message sent by the data processing server after transferring the inwardly transferred resources corresponding to the requested user from an associated account of the requested user into an associated account of the requesting user according to the resource outward-transfer request message.

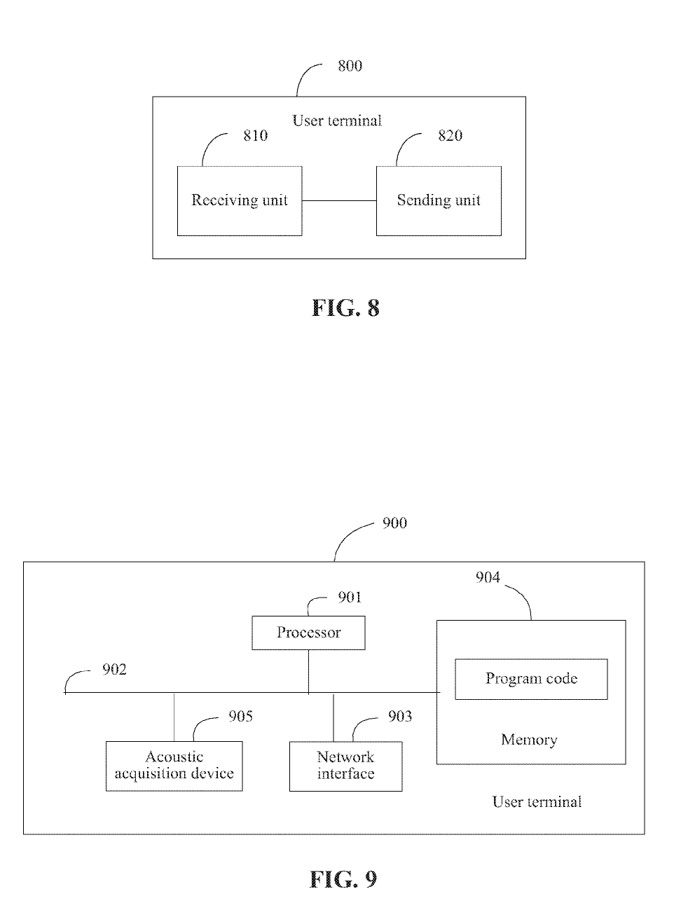

FIG. 8 is a schematic structural view of a user terminal of a requested user according to an embodiment of the present disclosure, the user terminal in this embodiment may include smart phones, tablet PCs, e-readers, vehicle terminals, wearable smart devices or the like, and as shown in FIG. 8, the user terminal 800 in this embodiment may at least include:

a receiving unit 810, for receiving a resource inward-transfer message sent by a data processing server, wherein the resource inward-transfer message is sent by the data processing server according to a received resource inward-transfer request sent by a user terminal of a requesting user, the resource inward-transfer request includes a user ID of the at least one requested user determined by the requesting user and inwardly transferred resources corresponding to each requested user, and the resource inward-transfer message includes user information of the requesting user and inwardly transferred resources corresponding to the requested user.

In an alternative embodiment, the receiving unit 810 may receive the resource inward-transfer message sent by the data processing server through a social application session between a user terminal of the requested user and the data processing server.

The resource inward-transfer message may, as shown in FIG. 11, include resource inward-transfer items, activity content, the number of inwardly transferred resources, user information of the requesting user and other information, and may let the requested user intuitively understand which user initiates the current resource inward-transfer message, what needs resource inward-transfer due to a matter or an activity, so as to rapidly decide whether resource outward-transfer is required.

A sending unit 820 is included, for sending a resource outward-transfer request message to the data processing server according to the resource inward-transfer message, so that the data processing server transfers the inwardly transferred resources corresponding to the requested user from an associated account of the requested user into an associated account of the requesting user according to the resource outward-transfer request message.

In specific implementation, the requested user may click on a resource outward-transfer link in the resource inward-transfer message so that the sending unit 820 returns a resource outward-transfer request message to the data processing server, which indicates agreeing with resource outward-transfer on the resource inward-transfer request.

In an alternative embodiment, the sending unit 820 is further used for sending a resource transfer query request to the data processing server according to the resource inward-transfer message;

the receiving unit 810 is further used for receiving a resource outward-transfer message returned by the data processing server according to the resource transfer query request, wherein the resource outward-transfer message is used for prompting the requested user to acknowledge whether resources are transferred to the requesting user; and

the sending unit 820 sends the resource outward-transfer request message to the data processing server according to the resource outward-transfer message. When the requested user further acknowledges resource outward-transfer according to the resource outward-transfer message, for example, clicks on a key or link of “I want resource outward-transfer” in the resource outward-transfer message, the user terminal of the requested user sends the resource outward-transfer request message to the data processing server.

In an alternative embodiment, after the sending unit 820 sends the resource outward-transfer request message to the data processing server according to the resource outward-transfer message, the receiving unit 810 is further used for receiving resource outward-transfer parameter information sent by the data processing server according to the resource outward-transfer request message, which may include the associated account of the requested user, the associated account of the requesting user, resource transfer amount and the like.

The sending unit 820 is further used for sending a resource outward-transfer request to a resource outward-transfer server according to the resource outward-transfer parameter information, so that the resource outward-transfer server transfers the inwardly transferred resources corresponding to the requested user from the associated account of the requested user into the associated account of the requesting user according to the resource outward-transfer request.

Specifically, after receiving the resource outward-transfer parameter information sent by the data processing server, the user terminal of the requested user may automatically invoke a resource outward-transfer initiate interface of the terminal, for example, a resource outward-transfer function of a social application terminal, to send a resource outward-transfer request to a preset resource outward-transfer server, wherein the resource outward-transfer request carries the resource outward-transfer parameter information.

The user terminal in this embodiment may, after receiving a resource inward-transfer message generated and sent by a data processing server according to a resource inward-transfer request sent by a requesting user, initiate resource outward-transfer and resource transfer according to the resource inward-transfer message, and it is unnecessary to input user account information in the resource inward-transfer process, which ensures security of the user account information, and achieves safe and efficient online resource inward-transfer.

FIG. 9 is a schematic structural view of a user terminal of a requested user according to another embodiment of the present disclosure, and as shown in FIG. 9, the user terminal 900 may include: at least one processor 901, for example, CPU, at least one network interface 903, a memory 904, a communication bus 902 and an acoustic acquisition device 905. The communication bus 902 is used for implementing connections and communications between the components. The acoustic acquisition device 905 is used for acquiring surrounding acoustic information, for example, a speaker, a microphone or other devices. The network interface 903 of the data processing server 900 in this embodiment of the present disclosure may include standard wired interfaces and wireless interfaces (for example, WI-FI interfaces), for communicating with a server via Internet. The memory 904 may be a high-speed RAM memory, or may be a non-volatile memory, for example, at least one magnetic disk memory. The memory 904, alternatively, may also be at least one storage device located away from the processor 901. The memory 904 stores a set of program codes, and the processor 901 is used for calling the program codes stored in the memory 904, and is used for executing the following operations:

receiving a resource inward-transfer message sent by a data processing server through the network interface 903, wherein the resource inward-transfer message is sent by the data processing server according to a received resource inward-transfer request sent by a user terminal of a requesting user, the resource inward-transfer request includes a user ID of at least one requested user determined by the requesting user and inwardly transferred resources corresponding to each requested user, and the resource inward-transfer message includes user information of the requesting user and inwardly transferred resources corresponding to the requested user.

In an alternative embodiment, the resource inward-transfer message sent by the data processing server may be received through a social application session between the user terminal 900 and the data processing server.

Send a resource outward-transfer request message to the data processing server through the network interface 903 according to the resource inward-transfer message, so that the data processing server transfers the inwardly transferred resources corresponding to the requested user from an associated account of the requested user into an associated account of the requesting user according to the resource outward-transfer request message.

In an alternative embodiment, the sending a resource outward-transfer request message to the data processing server through the network interface 903 according to the resource inward-transfer message includes:

sending a resource transfer query request to the data processing server through the network interface 903 according to the resource inward-transfer message;

receiving a resource outward-transfer message returned by the data processing server according to the resource transfer query request through the network interface 903, wherein the resource outward-transfer message is used for prompting the requested user to acknowledge whether resources are transferred to the requesting user; and

sending the resource outward-transfer request message to the data processing server through the network interface 903 according to the resource outward-transfer message.

In an alternative embodiment, the sending a resource outward-transfer request message to the data processing server through the network interface 903 according to the resource inward-transfer message, so that the data processing server transfers the inwardly transferred resources corresponding to the requested user from an associated account of the requested user into an associated account of the requesting user according to the resource outward-transfer request message includes:

sending a resource outward-transfer request message to the data processing server through the network interface 903 according to the resource inward-transfer message;

receiving resource outward-transfer parameter information sent by the data processing server according to the resource outward-transfer request message through the network interface 903; and

sending a resource outward-transfer request to a resource outward-transfer server through the network interface 903 according to the resource outward-transfer parameter information, so that the resource outward-transfer server transfers the inwardly transferred resources corresponding to the requested user from the associated account of the requested user into the associated account of the requesting user according to the resource outward-transfer request.

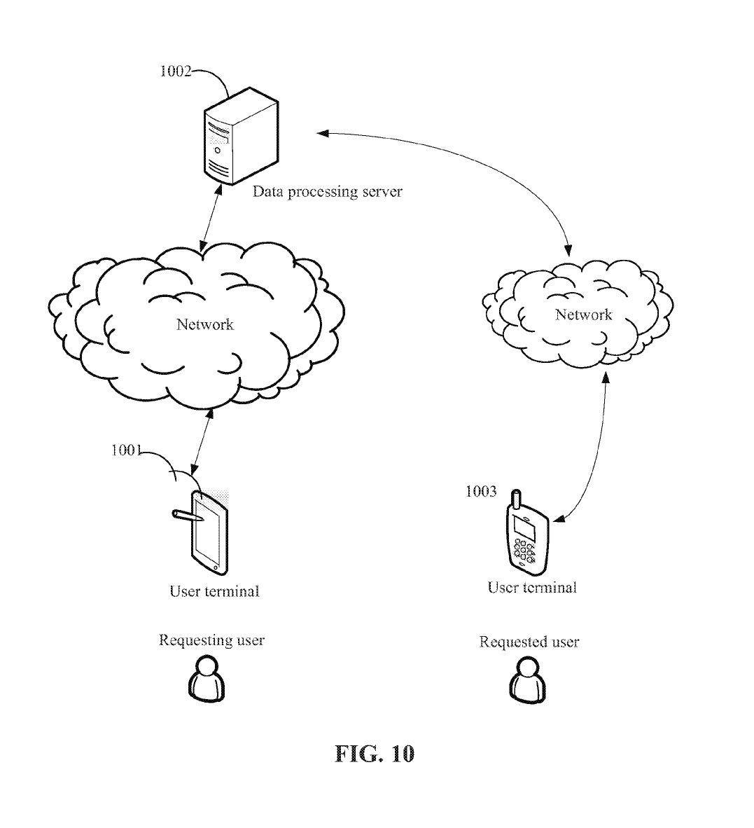

FIG. 10 is a schematic structural view of a data processing system according to an embodiment of the present disclosure, and as shown in FIG. 10, the data processing system in this embodiment of the present disclosure includes a user terminal 1001 of a requesting user, a data processing server 1002 and a user terminal 1003 of at least one requested user, wherein:

the user terminal 1001 of the requesting user is used for submitting a resource inward-transfer request to the data processing server 1002, wherein the resource inward-transfer request includes a user ID of at least one requested user determined by the requesting user and inwardly transferred resources corresponding to each requested user;

the data processing server 1002 receives the resource inward-transfer request submitted by the user terminal 1001 of the requesting user, and sends a resource inward-transfer message to the user terminal 1003 of the requested user according to the resource inward-transfer request, wherein the resource inward-transfer message includes user information of the requesting user and inwardly transferred resources corresponding to the requested user. Specifically, in an alternative embodiment, the data processing server 1002 may send a resource inward-transfer message to the user terminal of the requested user through a social application session with the requested user.

The user terminal 1001 of the requesting user is used for returning a resource outward-transfer message to the data processing server 1002 according to the resource inward-transfer message; and

the data processing server 1002 is further used for transferring the inwardly transferred resources corresponding to the requested user from an associated account of the requested user into an associated account of the requesting user according to the resource outward-transfer request message.

In an alternative embodiment, before submitting a resource inward-transfer request to the data processing server 1002, the user terminal 1001 of the requesting user is further used for determining at least one social application contact in social application contacts of the requesting user as the requested user.

In an alternative embodiment, before submitting a resource inward-transfer request to the data processing server 1002, the user terminal 1001 of the requesting user is further used for sending out acoustic information according to an operation that the requesting user presses down a resource inward-transfer initiate key;

the data processing server 1002 is further used for sending user information of a user terminal acquiring the acoustic information to the user terminal 1001 of the requesting user; and

the user terminal 1001 of the requesting user is further used for determining at least one user of the user terminal acquiring the acoustic information as the requested user.

In an alternative embodiment, that the data processing server 1002 receives a resource outward-transfer request message returned by the user terminal 1003 of the requested user according to the resource inward-transfer message includes:

the data processing server 1002 receiving a resource transfer query request sent by the user terminal 1003 of the requested user according to the resource inward-transfer message;

the data processing server 1002 returning a resource outward-transfer message to the user terminal 1003 of the requested user according to the resource transfer query request, wherein the resource outward-transfer message is used for prompting the requested user to acknowledge whether resources are transferred to the requesting user; and

the data processing server 1002 receiving a resource outward-transfer request message sent by the user terminal 1003 of the requested user according to the resource outward-transfer message.

In an alternative embodiment, that the data processing server 1002 transfers the inwardly transferred resources corresponding to the requested user from an associated account of the requested user into an associated account of the requesting user according to the resource outward-transfer request message includes:

the data processing server 1002 transferring the inwardly transferred resources corresponding to the requested user from an associated account of the requested user into a preset account of the data processing server 1002 according to the resource outward-transfer request message; and

the data processing server 1002 transferring the inwardly transferred resources corresponding to the requested user from the preset account of the data processing server 1002 into an associated account of the requesting user.

In an alternative embodiment, that the data processing server 1002 transfers the inwardly transferred resources corresponding to the requested user from an associated account of the requested user into an associated account of the requesting user according to the resource outward-transfer request message includes:

the data processing server 1002 sending resource outward-transfer parameter information to the user terminal 1003 of the requested user according to the resource outward-transfer request message;

the user terminal 1003 of the requested user sending a resource outward-transfer request to a resource outward-transfer server according to the resource outward-transfer parameter information, so that the resource outward-transfer server transfers the inwardly transferred resources corresponding to the requested user from the associated account of the requested user into the associated account of the requesting user according to the resource outward-transfer request.

In an alternative embodiment, the data processing server 1002, after transferring the inwardly transferred resources corresponding to the requested user from an associated account of the requested user into an associated account of the requesting user according to the resource outward-transfer request message, is further used for sending a resource transfer success message to the user terminal 1001 of the requesting user.

The data processing server in this embodiment of the present disclosure sends a resource inward-transfer message to a determined requested user according to a resource inward-transfer request sent by a requesting user, so that the requested user may initiate resource outward-transfer according to the resource inward-transfer message, and it is unnecessary to input user account information in the resource inward-transfer process, which ensures security of the user account information, and achieves safe and efficient online resource inward-transfer.

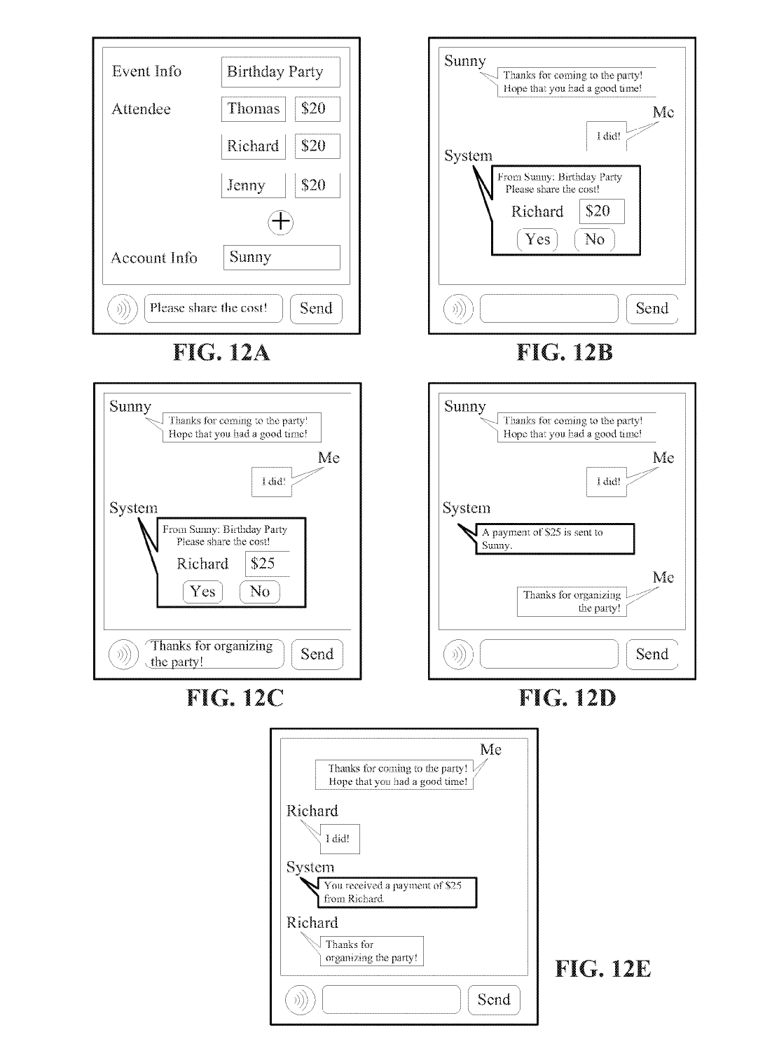

FIGS. 12A-12E are exemplary screenshots of displaying resource transfer related messages in a social networking application running on user terminals according to an embodiment of the present disclosure. In some embodiments, the data processing server described above is used for implementing a social networking application, e.g., an instant messaging application like WeChat. The resource transfer function as described in the present disclosure is one of the many features supported by the social networking application. The nature of the social networking application makes it an appropriate platform for a group of users to organize an event, e.g., a birthday party, by exchanging information with one another. Quite often, an organizer prepays the expense of organizing the event and then seeks reimbursement or contributions from the attendees. Therefore, it would be beneficial if the contribution collection process is also completed through the same social networking application. For illustrative purposes, the set of screenshots are described below to highlight how the contribution collection process is performed at the data processing server.

Assume that a user of the social networking application called “Sunny” has organized a birthday party attended by users “Thomas”, “Richard” and “Jenny” and Sunny would like to invite the other attendees to contribute some money to the expense. To do so, Sunny starts his social networking application from his user terminal (e.g., a smartphone) and selects the resource transfer function supported by the social networking application. FIG. 12 A depicts a screenshot of the resource transfer function implemented on the user terminal. In this case, Sunny needs to prepare and send a message to notify the other attendees of how much he wants them to contribute. Note that this message is a structured message that includes multiple components, e.g., an event title “Birthday Party”, one or more recipient user accounts of the message, each recipient user account selected from Sunny's user contact list and corresponding to one of the attendees of the party, and a user account for making the contribution request (which is Sunny himself). In some embodiments, there is a specific amount of resource expected from each attendee, e.g., $20 from each of the three attendees. In some other embodiments, the message may not specify the amount expected from each attendee and the recipient of the message can determine how much he or she wants to contribute.

In some embodiments, since this resource transfer function is implemented in a social networking application, the basic function of the social networking application is kept together with the resource transfer function. As shown in FIG. 12A, Sunny can compose a separate text message in addition to the structured message related to resource transfer. In some embodiments, Sunny can even prepare an audio message in addition to the structured message related to resource transfer. Finally, a user selection of the Send button in FIG. 12A triggers the submission of the structured message as well as the additional message (if existing) to the data process server.

Upon receipt of the structured message, the data process server understands that this message requires special treatment. For example, the data process server extracts the information items in the structured message including the event title, one or more recipient user accounts and respective resources requested from the recipient user accounts, and the requesting user account. For each recipient user account, the data process server generates and sends a structured request to a respective user terminal associated with the recipient user account, the structured request including the event title, the requesting user account, and an amount of resource requested by the requesting user account, and one or more user-actionable items. FIG. 12B depicts such a structured request on a user terminal associated with Richard. In some embodiments, the structured request received by the respective user terminal is displayed in the context of a sequence of messages exchanged between the requesting user account and the recipient user account using the social networking application. For example, there are two regular messages between Sunny and Richard located above the structured request. As shown in FIG. 12B, the structured request has a different visual cue from the other regular messages. In this example, the structured request includes the amount requested by Sunny, $20. But this field is user-editable. In other words, Richard can change the amount by clicking this field. As shown in FIG. 12C, Richard changes the amount of his contribution from $20 to $25. In some embodiments, the structured request is shown to be from the System (not Sunny), indicating that this is a special type of message appearing on the display and requiring additional attention.

As shown in FIG. 12C, Richard selects the Yes button to approve the amount to be deducted from his user account or the No button to disapprove the amount. In some embodiments, the selection of the Yes button triggers an alert message to be displayed on the user terminal when the predefined amount of resource authorized by the recipient user account is less than the amount of resource requested by the requesting user account. Like the initial structured message, the recipient user Richard can also compose a separate, regular message using the social networking application and send a structured response back to the data process server, the structured response including the event title, the requesting user account, and an authorization of transferring a predefined amount of resource to the requesting user account.

Upon receipt of the structured response, the data process server then performs a resource transfer operation between the recipient user account and the requesting user account in accordance with the predefined amount. In this example, the data process server transfers $25 from Richard's account to Sunny's account. After the completion of the resource transfer, the data process server sends structured messages to the respective user terminals. As shown in FIGS. 12D and 12E, the structured message to Sunny's user terminal indicates that a predefined amount of resource has been transferred from a respective recipient user account to the requesting user account and the structured message to Richard's indicates that the predefined amount of resource has been transferred to the requesting user account. Note that both messages are like a regular message but with slightly different visual appearance including the sending of the message being “System.” In some embodiments, after receiving the structured response from the respective user terminal and before performing the transfer, the data process server queries a user account database of the social networking application for the recipient user account to determine whether the recipient user account has sufficient amount of resource for transferring the predefined amount of resource to the requesting user account. When the recipient user account does not have sufficient amount of resource for transferring the predefined amount of resource to the requesting user account, the data process server returns an error message to the respective user terminal. After the user deposits sufficient fund into his or her account, the data process server then resends the structured request like the one shown in FIG. 12C. In some other embodiments, the data process server does not resend the structured request but goes ahead performing the resource transfer in accordance with the amount authorized by the recipient user.

While particular embodiments are described above, it will be understood it is not intended to limit the present disclosure to these particular embodiments. On the contrary, the present disclosure includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present disclosure herein is for the purpose of describing particular embodiments only and is not intended to be limiting of the present disclosure. As used in the description of the present disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the present disclosure and its practical applications, to thereby enable others skilled in the art to best utilize the present disclosure and various embodiments with various modifications as are suited to the particular use contemplated.

What is claimed is:

1. A method of conducting resource transfer using a social networking application, the method comprising:
at a computer server having one or more processors and memory storing programs executed by the one or more processors:
receiving a structured message from a first user terminal, the structured message including an event title, one or more recipient user accounts and respective resources requested from the recipient user accounts, and a requesting user account;
for each of the one or more recipient user accounts:
sending a structured request to a respective user terminal associated with the recipient user account, the structured request including the event title, the requesting user account, and an amount of resource requested by the requesting user account, and one or more user-actionable items;
receiving a structured response from the respective user terminal, the structured response including the event title, the requesting user account, and an authorization of transferring a predefined amount of resource to the requesting user account; and
performing a resource transfer operation between the recipient user account and the requesting user account in accordance with the predefined amount; and
sending structured messages to the respective user terminals, wherein the structured message to the first user terminal indicates that a predefined amount of resource has been transferred from a respective recipient user account to the requesting user account and the structured message to the user terminal associated with the respective recipient user account indicates that the predefined amount of resource has been transferred to the requesting user account.

2. The method of claim 1, wherein the structured request received by the respective user terminal is displayed in the context of a sequence of messages exchanged between the requesting user account and the recipient user account using the social networking application.

3. The method of claim 2, wherein the structured request is displayed in a visually different manner from the sequence of messages.

4. The method of claim 1, wherein the predefined amount of resource authorized by the recipient user account is different from the amount of resource requested by the requesting user account.

5. The method of claim 4, wherein, when the predefined amount of resource authorized by the recipient user account is less than the amount of resource requested by the requesting user account, an alert message is displayed on the corresponding user terminal.

6. The method of claim 1, wherein the structured message from the first user terminal further includes a message composed by a user of the first user terminal.

7. The method of claim 6, wherein the message composed by the user of the first user terminal is an audio message recorded by the first user terminal.

8. The method of claim 1, wherein the recipient user accounts are selected from a user contacts list of the requesting user account.

9. The method of claim 1, further comprising:
after receiving the structured response from the respective user terminal:
querying a user account database for the recipient user account to determine whether the recipient user account has sufficient amount of resource for transferring the predefined amount of resource to the requesting user account; and
returning an error message to the respective user terminal when the recipient user account does not have sufficient amount of resource for transferring the predefined amount of resource to the requesting user account.

10. A computer system, comprising:
one or more processors;
memory; and
one or more programs modules stored in the memory and configured for execution by the one or more processors, the one or more program modules including instruction for:
receiving a structured message from a first user terminal, the structured message including an event title, one or more recipient user accounts and respective resources requested from the recipient user accounts, and a requesting user account;
for each of the one or more recipient user accounts:
sending a structured request to a respective user terminal associated with the recipient user account, the structured request including the event title, the requesting user account, and an amount of resource requested by the requesting user account, and one or more user-actionable items;
receiving a structured response from the respective user terminal, the structured response including the event title, the requesting user account, and an authorization of transferring a predefined amount of resource to the requesting user account; and
performing a resource transfer operation between the recipient user account and the requesting user account in accordance with the predefined amount; and
sending structured messages to the respective user terminals, wherein the structured message to the first user terminal indicates that a predefined amount of resource has been transferred from a respective recipient user account to the requesting user account and the structured message to the user terminal associated with the respective recipient user account indicates that the predefined amount of resource has been transferred to the requesting user account.

11. The computer system of claim 10, wherein the structured request received by the respective user terminal is displayed in the context of a sequence of messages exchanged between the requesting user account and the recipient user account using the social networking application.

12. The computer system of claim 10, wherein the predefined amount of resource authorized by the recipient user account is different from the amount of resource requested by the requesting user account.

13. The computer system of claim 10, wherein the structured message from the first user terminal further includes a message composed by a user of the first user terminal.

14. The computer system of claim 10, wherein the recipient user accounts are selected from a user contacts list of the requesting user account.

15. The computer system of claim 10, wherein the one or more program modules further include instruction for:
after receiving the structured response from the respective user terminal:
querying a user account database for the recipient user account to determine whether the recipient user account has sufficient amount of resource for transferring the predefined amount of resource to the requesting user account; and
returning an error message to the respective user terminal when the recipient user account does not have sufficient amount of resource for transferring the predefined amount of resource to the requesting user account.

16. A non-transitory computer readable storage medium having stored therein one or more instructions, which, when executed by a computer system, cause the computer system to perform the following instructions:
receiving a structured message from a first user terminal, the structured message including an event title, one or more recipient user accounts and respective resources requested from the recipient user accounts, and a requesting user account;
for each of the one or more recipient user accounts:
sending a structured request to a respective user terminal associated with the recipient user account, the structured request including the event title, the requesting user account, and an amount of resource requested by the requesting user account, and one or more user-actionable items;
receiving a structured response from the respective user terminal, the structured response including the event title, the requesting user account, and an authorization of transferring a predefined amount of resource to the requesting user account; and
performing a resource transfer operation between the recipient user account and the requesting user account in accordance with the predefined amount; and
sending structured messages to the respective user terminals, wherein the structured message to the first user terminal indicates that a predefined amount of resource has been transferred from a respective recipient user account to the requesting user account and the structured message to the user terminal associated with the respective recipient user account indicates that the predefined amount of resource has been transferred to the requesting user account.

17. The non-transitory computer readable storage medium of claim 16, wherein the structured request received by the respective user terminal is displayed in the context of a sequence of messages exchanged between the requesting user account and the recipient user account using the social networking application.

18. The non-transitory computer readable storage medium of claim 16, wherein the predefined amount of resource authorized by the recipient user account is different from the amount of resource requested by the requesting user account.

19. The non-transitory computer readable storage medium of claim 16, wherein the structured message from the first user terminal further includes a message composed by a user of the first user terminal.

20. The non-transitory computer readable storage medium of claim 16, wherein the recipient user accounts are selected from a user contacts list of the requesting user account.

21. The non-transitory computer readable storage medium of claim 16, wherein the one or more program modules further include instruction for:
after receiving the structured response from the respective user terminal:
querying a user account database for the recipient user account to determine whether the recipient user account has sufficient amount of resource for transferring the predefined amount of resource to the requesting user account; and
returning an error message to the respective user terminal when the recipient user account does not have sufficient amount of resource for transferring the predefined amount of resource to the requesting user account.
